(19) United States
(12) Patent Application Publication
(10) Pub. No.: US 2021/0095842 A1
(43) Pub. Date: Apr. 1, 2021

(54) LUMINAIRE HOUSING

(71) Applicant: BEKA SCHREDER (PROPRIETARY) LTD, Olifantsfontein (ZA)

(72) Inventors: Daniel Kasper, (US); Irwin Russel, (US); Marius Scott, (US)

(21) Appl. No.: 15/733,432

(22) PCT Filed: Jan. 30, 2019
(86) PCT No.: PCT/IB2019/050748

§ 371 Date: Jul. 29, 2020

(30) Foreign Application Priority Data
Jan. 30, 2018 (BE) 20185052
Jan. 30, 2018 (ZA) 201800622

(51) Int. Cl. F21V 31/00; F21V 7/05

(52) U.S. Cl. CPC F21V 31/005; F21Y 2105/10; F21V 7/05

(57) ABSTRACT

A luminaire housing comprising a base component defining a first cavity, the first cavity corresponding to a control gear housing for accommodating luminaire control gear; a lighting sub-assembly securable to the base component so as to cover and enclose the first cavity, the lighting sub-assembly comprising an intermediate plate carrying lighting elements, a cover, and a first seal arrangement between the cover and the intermediate plate so as to define a sealed lighting sub-assembly; and a second seal arrangement between the lighting sub-assembly and the base component, wherein the base component includes at least one mounting formation outside the first cavity and the lighting sub-assembly, to enable the luminaire housing to be fitted to a supporting structure, so as to prevent the ingress of moisture and other contaminants into the first cavity and the lighting sub-assembly.

### FIELD OF THE INVENTION

THIS INVENTION relates to a luminaire housing, and in particular to a wall mounted, exterior luminaire housing.

### BACKGROUND OF THE INVENTION

Exterior luminaire housings need to be particularly robust to prevent the ingress of moisture and other contaminants, which may affect the operation of the luminaire. A typical luminaire housing comprises a base, which may be fitted to a supporting structure (such as a wall), and a cover mounted to the base. The base and the cover define a lamp compartment for accommodating the electrical components and the lighting elements, which are mounted to the base.

Typically, to enable the luminaire housing to be fitted to the supporting structure, mounting holes are defined within the base, and thus within the lamp compartment itself. This makes the luminaire housing susceptible to the ingress of moisture and other contaminants, and thus severely compromises the IP rating of the lamp compartment. A single seal may sometimes be provided between the base and the cover, but this does not fully prevent the ingress of moisture and other contaminants into the lamp compartment.

In addition, since the electrical components are typically directly secured to the base, it is cumbersome and difficult to replace or upgrade any of these components.

It is therefore the object of the present invention to provide a luminaire housing that has better sealing characteristics and is more versatile in terms of replacing/upgrading any of the electrical components.

### SUMMARY OF THE INVENTION

According to a first aspect of the present invention there is provided a luminaire housing comprising:
a base component defining a first cavity, the first cavity corresponding to a control gear housing for accommodating luminaire control gear;
a lighting sub-assembly securable to the base component so as to cover and enclose the first cavity, the lighting sub-assembly comprising an intermediate plate carrying lighting elements, a cover, and a first seal arrangement between the cover and the intermediate plate so as to define a sealed lighting sub-assembly; and
a second seal arrangement between the lighting sub-assembly and the base component, wherein the base component includes at least one mounting formation outside the first cavity and the lighting sub-assembly, to enable the luminaire housing to be fitted to a supporting structure, so as to prevent the ingress of moisture and other contaminants into the first cavity and the lighting sub-assembly.

In an embodiment, the base component comprises:
a base wall;
a first, inner peripheral wall that defines the first cavity; and
a second, outer peripheral wall that surrounds the first, inner peripheral wall.

In an embodiment, an outer side of the intermediate plate defines a first peripheral sealing channel to accommodate a first sealing body therein, the first sealing body corresponding to the first seal arrangement, with a first securing arrangement being provided to releasably and sealingly secure the cover against the first sealing body so as to define the sealed lighting sub-assembly.

In an embodiment, the lighting sub-assembly is securable to the base component via a second securing arrangement, so as to sealingly engage the second seal arrangement.

Series 300

In one version of the invention, an inner side of the cover includes a transversely extending sealing rim arranged to abut against the first sealing body within the first peripheral sealing channel of the intermediate plate (to improve the seal between these two components).

In an embodiment, the first securing arrangement comprises a plurality of clipping arrangements, typically comprising a plurality of downwardly extending flanges extending from the cover and a corresponding plurality of securing tabs on the intermediate plate to engage the downwardly extending flanges.

In an embodiment, the clipping arrangements of the first securing arrangement are snap fit clipping arrangements, with the downwardly extending flanges defining apertures to receive the securing tabs in a snap fit, relatively permanent manner.

In an embodiment, the second, outer peripheral wall defines a peripheral skirt that surrounds the base wall, with the first, inner peripheral wall and the second, outer peripheral wall accordingly extending away from, so as to be transverse to, the base wall, with the intermediate plate of the lighting sub-assembly accordingly being substantially parallel to the base wall.

In an embodiment, the second securing arrangement comprises a plurality of locking formations disposed around the periphery of the intermediate plate, the locking formations defining apertures for receiving locking members that extend through corresponding apertures defined in the peripheral skirt of the base component.

In an embodiment, a flange extends between the first and second peripheral walls, the flange defining a plurality of the mounting formations, to enable the base component to be mounted to the supporting structure, each mounting formation comprising a mounting body defining an elongate slot to accommodate a securing member.

In an embodiment, the flange extending between the first and second peripheral walls defines a second peripheral sealing channel, around the first cavity, to accommodate a second sealing body therein, the second sealing body corresponding to the second seal arrangement.

In an embodiment, the intermediate plate comprises:
a plate portion for accommodating the lighting elements;
an inwardly extending peripheral ring to abut against the second sealing body provided in the second sealing channel of the flange; and
a peripheral plate wall extending outwardly from the plate portion, with the first peripheral sealing channel being defined around the peripheral plate wall.

Wall Pack

In another version of the invention, the first, inner peripheral wall and the second, outer peripheral wall are adjacent the base wall, with a plate portion of the intermediate plate (also called intermediate support) of the lighting sub-assembly accordingly being at an angle, preferably substantially transverse (i.e. at right angles) to the base wall, with the base wall having a mounting wall plate portion that extends away from the lighting sub-assembly, with the mounting wall plate portion defining the mounting formation to enable the base component to be mounted to the supporting structure.

In an embodiment, the lighting sub-assembly comprises a securing frame that can be releasably secured with the first securing arrangement (typically with bolts) to the intermediate plate. The cover may comprise a planar (glass) plate or any other suitably shaped transparent or translucent element. The securing frame may be arranged to sealingly sandwich the planar plate against the first sealing body arranged within the first peripheral sealing channel.

In an embodiment, an inner side of the intermediate plate defines a second peripheral sealing channel to accommodate a second sealing body therein, the second sealing body corresponding to the second seal arrangement and being arranged to be sealingly fitted against the first, inner peripheral wall of the base component with the second securing arrangement.

In an embodiment, the second securing arrangement comprises a plurality of locking formations disposed around the inside of the second peripheral wall, the locking formations defining apertures for receiving locking members that extend through corresponding apertures defined in corresponding locking formations on the intermediate plate.

In an embodiment, the intermediate plate comprises: a plate portion for accommodating the lighting elements. For example, the lighting elements may be light emitting diodes arranged on a PCB which is arranged on the plate portion. The plate portion may be provided with a peripheral portion defining the second peripheral sealing channel. The intermediate plate may further comprise a peripheral plate wall extending outwardly from the plate portion, the peripheral plate wall defining the first peripheral sealing channel and a peripheral flange that includes the locking formations on an inner side of the peripheral flange.

In an embodiment, the intermediate plate further comprises a reflector plate that extends away from the plate portion. Preferably, the reflector plate is arranged to cover the mounting wall plate portion of the base wall. The reflector plate may comprise a plurality of angled reflector strips, and may terminate in a rearwardly extending support plate that can abut against a lower end of the mounting wall plate portion of the base wall. Alternatively or in addition, the mounting wall plate portion is provided with a forwardly extending wall plate that can abut against the reflector plate. Also, instead of reflector strips the reflector plate may be provided with any other suitable reflective elements suitable for reflecting light emitted by the light emitting elements.

In an embodiment, the mounting wall plate portion includes side holding plates with inwardly turned lips to snugly accommodate the reflector plate. Alternatively or in addition, the reflector plate may be provided with side plates joining edges of the mounting wall plate portion.

According to a second aspect of the invention, there is provided a luminaire comprising a base component and a lighting sub-assembly. The base component comprises a base wall and a body fitted to the base wall. The body comprises a first, inner peripheral wall and a second outer wall. The first, inner peripheral wall defines a first cavity at a distance of the base wall, the first cavity corresponding to a control gear housing for accommodating luminaire control gear. The second outer wall is arranged such that the second outer wall and the base wall surround the first, inner peripheral wall. The lighting sub-assembly is secured to the body at a location outside of the first cavity and so as to cover and enclose the first cavity. The lighting sub-assembly comprises an intermediate support (also called intermediate plate in the embodiments above) carrying lighting elements and a transparent or translucent cover. The base wall includes at least one mounting formation outside the first cavity and the lighting sub-assembly, to enable the luminaire housing to be fitted to a supporting structure, such as a wall.

By having a first, inner peripheral wall, on the one hand, and a second outer wall and base wall on the other hand, there is provided a luminaire which can be easily fitted to a supporting structure, such as a wall, whilst at the same time providing a closed cavity for control gear. By securing the lighting sub-assembly to the body, outside of the first cavity, e.g. using a locking formation located between the first inner wall and the second outer wall, the lighting sub-assembly can at the same time close the first cavity.

Preferably, the base wall includes a mounting wall plate portion that extends away from the lighting sub-assembly, with the mounting wall plate portion defining the at least one mounting formation to enable the base component to be mounted to the supporting structure. It is noted that the base wall may comprise a mounting wall plate portion that extends downwardly and/or a mounting wall plate portion that extends upwardly.

By having the plate portion extending away from the lighting sub-assembly, the at least one mounting formation can be more easily accessible when mounting the base wall against a supporting structure.

Preferably, the intermediate support comprises a plate portion extending at an angle of 90°+/−30° with respect to the base wall, said plate portion carrying the lighting elements. More preferably, the angle is within a range of 90°+/−10°.

According to an exemplary embodiment, the intermediate support comprises a housing wall portion extending at an angle with respect to the plate portion. The housing wall portion is configured to form, together with the base component, a rear housing with an internal space between the base wall and the housing wall portion of the intermediate support. Optionally, the rear housing formed by the base component and the intermediate support defines an internal space extending behind the first cavity and below and/or above the first cavity.

The base wall may be provided with an aperture for passing cables from the supporting structure (e.g. a wall) through the rear housing to the first cavity.

Preferably, the housing wall portion of the intermediate support of the lighting sub-assembly is configured to be reflective. To that end, an outer surface of the housing wall portion may comprise reflective strips and/or any other reflective elements.

Preferably, the intermediate support is secured to one or more locking formations located in between the first inner wall and the second outer wall. In that manner, the locking formation can be hidden, and the plate portion of the intermediate support of the lighting sub-assembly can be fitted against the first inner peripheral wall to delimit the first cavity.

Preferably, the base wall extends substantially parallel to the second outer wall.

Preferably, the lighting sub-assembly comprises a first seal arrangement between the cover and the intermediate support so as to define a sealed lighting sub-assembly. In that manner, the lighting elements can be arranged in a sealed compartment between the cover and the intermediate support.

Preferably, a second seal arrangement is provided between the lighting sub-assembly and the base component. In that manner, a sealed first cavity is provided for the control gear.

According to an exemplary embodiment, an outer side of the intermediate support defines a first peripheral sealing channel to accommodate a first sealing body therein, the first sealing body corresponding to the first seal arrangement, with a first securing arrangement being provided to releasably and sealingly secure the cover against the first sealing body so as to define the sealed lighting sub-assembly, with the lighting sub-assembly being securable to the base component via a second securing arrangement, so as to sealingly engage the second seal arrangement.

### BRIEF DESCRIPTION OF THE DRAWINGS

FIG. 1 shows a top perspective view of a luminaire housing according to a first embodiment of the invention;

FIG. 2 shows a bottom perspective view of the luminaire housing shown in FIG. 1;

FIG. 3 shows an exploded view of the luminaire housing shown in FIGS. 1 and 2;

FIG. 4 shows a cross-sectional side view of the luminaire housing shown in FIGS. 1 to 3;

FIG. 5 shows a bottom, exploded perspective view of a luminaire housing according to a second embodiment of the invention;

FIG. 6 shows a bottom, perspective view of a base component used in the luminaire housing shown in FIG. 5;

FIG. 7 shows a rear, perspective view of the base component shown in FIG. 6;

FIG. 8 shows a top, exploded perspective view of the luminaire housing shown in FIG. 5;

FIG. 9 shows a detailed exploded view of a lighting sub-assembly of the luminaire housing shown in FIGS. 5 and 8;

FIG. 10 shows a detailed cross-sectional side view of the lighting sub-assembly shown in FIG. 9, once assembled; and

FIG. 11 shows a bottom perspective view of the fully assembled luminaire housing shown in FIG. 5.

### DETAILED DESCRIPTION OF AN EXAMPLE EMBODIMENT

The following description of the invention is provided as an enabling teaching of the invention. Those skilled in the relevant art will recognise that many changes can be made to the embodiment described, while still attaining the beneficial results of the present invention. It will also be apparent that some of the desired benefits of the present invention can be attained by selecting some of the features of the present invention without utilising other features. Accordingly, those skilled in the art will recognise that modifications and adaptations to the present invention are possible and can even be desirable in certain circumstances, and are a part of the present invention. Thus, the following description is provided as illustrative of the principles of the present invention and not a limitation thereof.

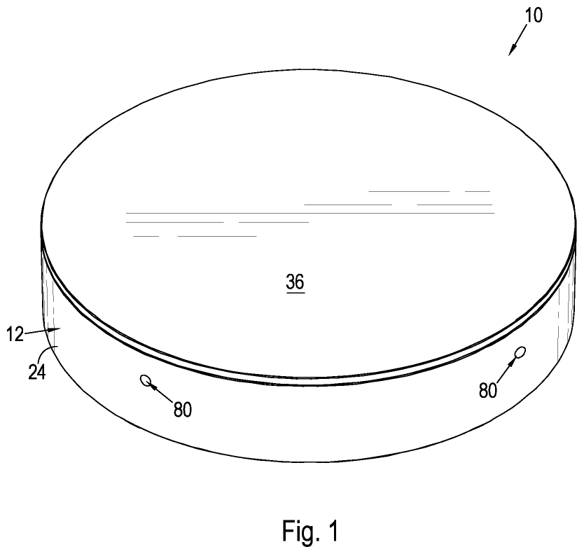

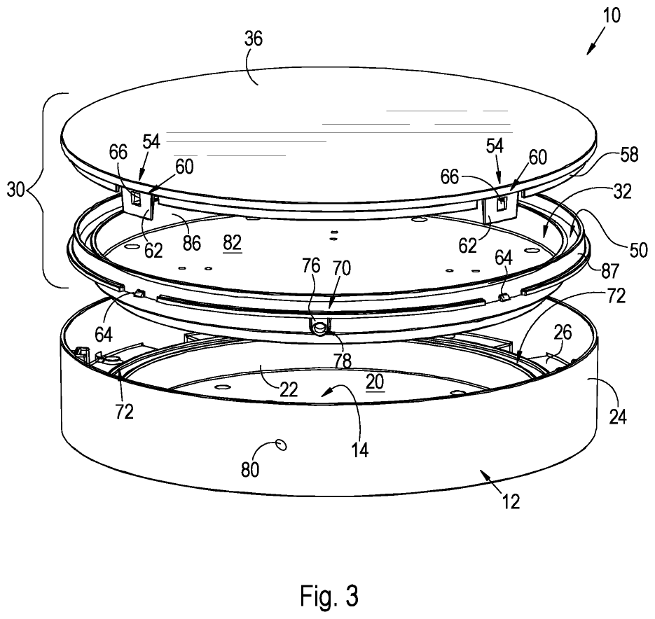

Referring first to FIGS. 1 to 4, a luminaire housing 10 comprises a base component 12 defining a first cavity 14. The first cavity 14 corresponds to a control gear housing for accommodating luminaire control gear, connector blocks, a battery, etc.

The base component 12 in turn comprises a base wall 20, a first, inner peripheral wall 22 that defines the first cavity 14, and a second, outer peripheral wall 24 that surrounds the first, inner peripheral wall 22, with a flange 26 extending between the first and second peripheral walls 22, 24.

The base wall 20 of the base component 12 comprises a plurality of mounting bosses 28, to which the control gear and related electrical components may be fitted. Advantageously, no drilling is required, thereby maintaining the sealing integrity of the first cavity 14 with the electrical components being directly securable on top of the bosses 28.

The luminaire housing 10 further comprises a lighting sub-assembly 30 that is securable to the base component 12 so as to cover and enclose the first cavity 14. The lighting sub-assembly 30 comprises an intermediate plate 32 carrying lighting elements 34 (typically, an array of LED lights), a translucent, slightly curved cover 36, and a first seal arrangement 38 between the cover 36 and the intermediate plate 32 so as to define a sealed lighting sub-assembly 30. In one particular version of this embodiment, the IP rating of the sealed lighting sub-assembly 30 is 65.

In an embodiment, the second, outer peripheral wall 24 defines a peripheral skirt that surrounds the base wall 20, with the first, inner peripheral wall 22 and the second, outer peripheral wall 24 accordingly extending away from, so as to be transverse to, the base wall 20; the intermediate plate 32 of the lighting sub-assembly 30 is accordingly substantially parallel to the base wall 20.

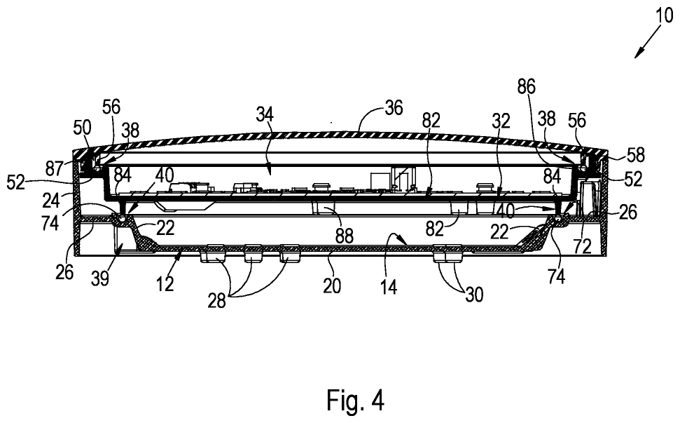

The flange 26 thus defines a peripheral stepped arrangement 39, as best shown in FIG. 4, the flange 26 extending substantially midway along the height of the peripheral skirt of the outer peripheral wall 24.

A second seal arrangement 40, as best shown in FIG. 4, is provided between the lighting sub-assembly 30 and the base component 12, so as to seal the first cavity 14 (and thus the control gear housing that accommodates the luminaire control gear). In one particular version of this embodiment, the IP rating of the sealed first cavity 14 is 65.

In broad terms, the base component 12 includes at least one mounting formation 42 outside the first cavity 14 and the lighting sub-assembly 30, to enable the luminaire housing 10 to be fitted to a supporting structure, such as a wall. This arrangement prevents the ingress of moisture and other contaminants into the first cavity 14 and the lighting sub-assembly 30, thus maintaining/ensuring the IP ratings of both.

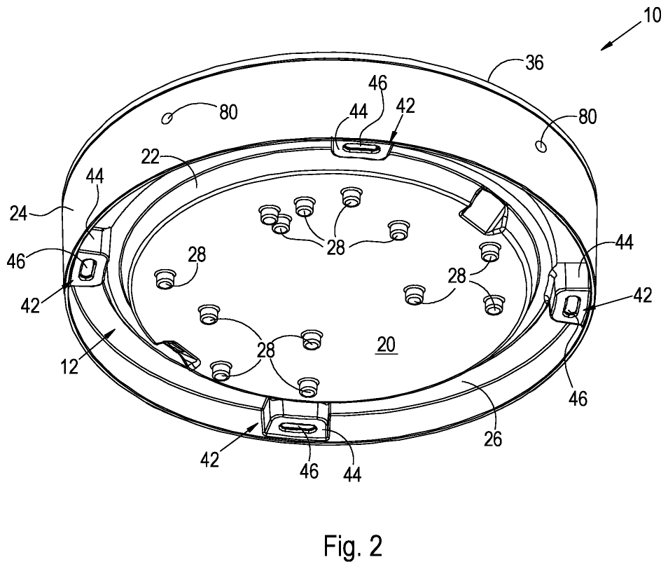

In this version, the flange 26 extending between the first and second peripheral walls 22, 24 defines a plurality of mounting formations 42, as best shown in FIG. 2 of the drawings. Each mounting formation 42 comprises a mounting body 44 defining an elongate slot 46 to accommodate a securing member (such as a screw, although not shown). Advantageously, the elongate slot 46 allows adjustments to be made during mounting, without having to re-drill into the wall.

An outer side of the intermediate plate 32 defines a first peripheral sealing channel 50 to accommodate a first sealing body 52 therein, such as a silicon gasket ring, the first sealing body 52 corresponding to the first seal arrangement 38.

A first securing arrangement 54 is provided to sealingly secure, in a relatively permanent manner, the cover 36 against the first sealing body 52 so as to define the sealed lighting sub-assembly 30 described above. An inner side of the cover 36 includes a transversely extending inner sealing rim 56 arranged to abut against the first sealing body 52 within the first peripheral sealing channel 50 of the intermediate plate 32, to improve the seal between these two components.

In this version, the first securing arrangement 54 comprises a plurality of clipping arrangements 60, typically comprising a plurality of downwardly extending flanges 62 extending from the cover 36 and a corresponding plurality of securing tabs 64 on the intermediate plate 32 to engage the downwardly extending flanges 62.

In an embodiment, the clipping arrangements 60 of the first securing arrangement 54 are snap fit clipping arrangements, with the downwardly extending flanges 62 defining apertures 66 to receive the securing tabs 64 in a snap fit, relatively permanent manner.

The lighting sub-assembly 30 is securable to the base component 12 via a second securing arrangement 70, so as to sealingly engage the second seal arrangement 40. The flange 26 extending between the first and second peripheral walls 22, 24 defines a second peripheral sealing channel 72, around the first cavity 14, to accommodate a second sealing body 74 therein, such as a silicon gasket ring, the second sealing body 74 corresponding to the second seal arrangement 40. This seals the first cavity 14 (and thus the control gear housing that accommodates the luminaire control gear), as described above.

In an embodiment, the second securing arrangement 70 comprises a plurality of locking formations 76 disposed around the periphery of the intermediate plate 32, the locking formations 76 defining apertures 78 for receiving locking members (not shown, but typically screws) that extend through corresponding apertures 80 defined in the peripheral skirt of the outer peripheral wall 24 of the base component 12.

In an embodiment, the intermediate plate 32 comprises a plate portion 82 for accommodating the lighting elements 34, an inwardly extending peripheral ring 84 to abut against the second sealing body 74 provided in the second sealing channel 72 of the flange 26, and a peripheral plate wall 86 extending outwardly from the plate portion 82, with the first peripheral sealing channel 50 being defined around the peripheral plate wall 86. An inner side of the cover 36 includes a transversely extending outer sealing rim 58 to frictionally against the outside of an outer flange 87 of the peripheral plate wall 86, as best shown in FIG. 4.

In an embodiment, the flat plate portion 82 of the intermediate plate 32 comprises a plurality of mounting bosses 88 to which the lighting elements 34 (and related electrical components) may be fitted. Again, as indicated above, no drilling is required, with the lighting elements 34 (and related electrical components) being directly securable on top of the bosses 88.

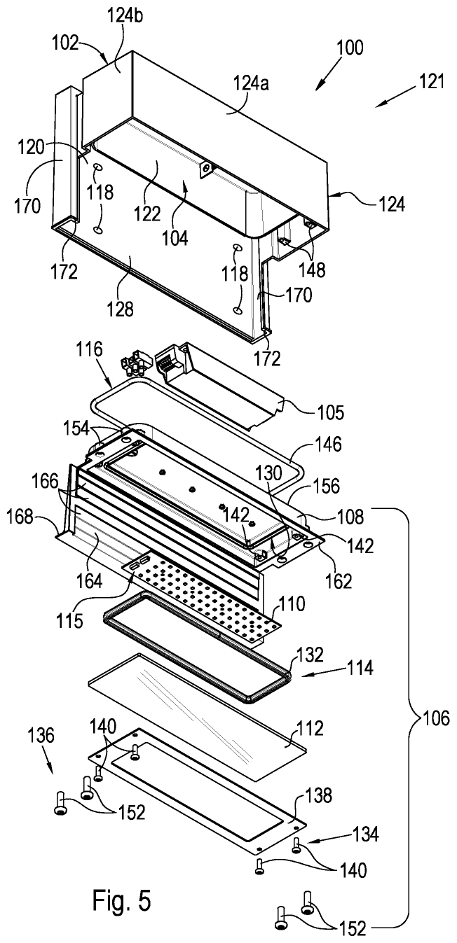

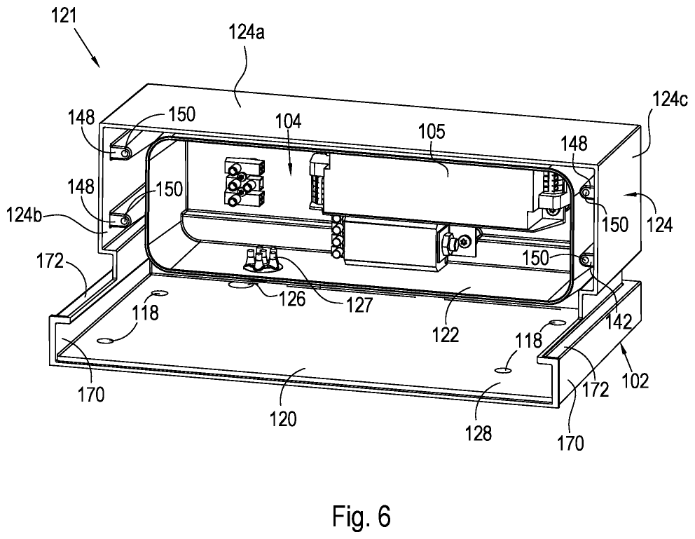

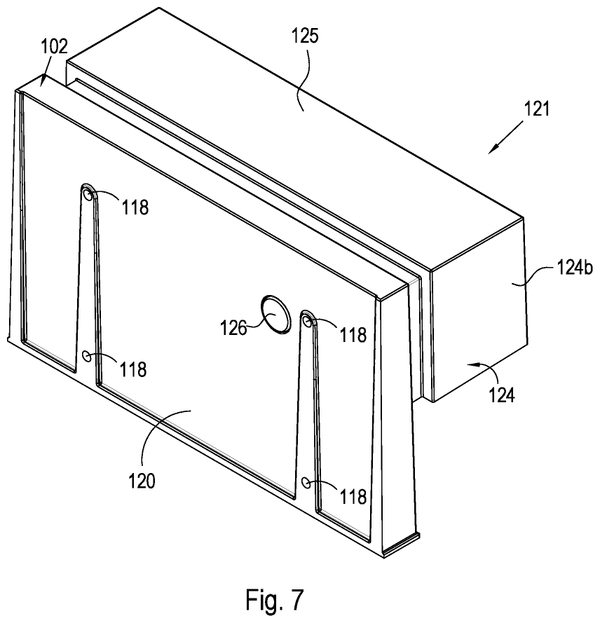

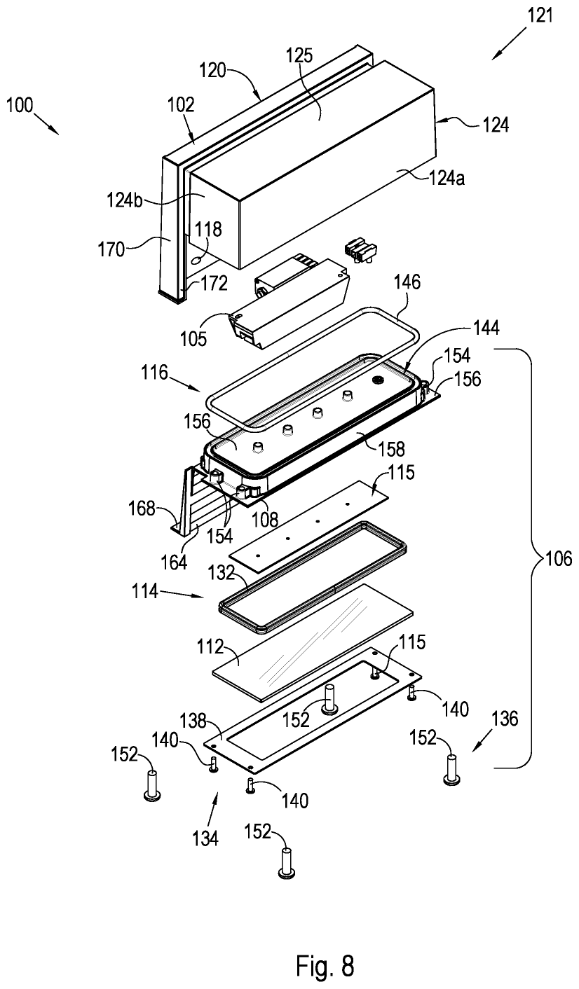

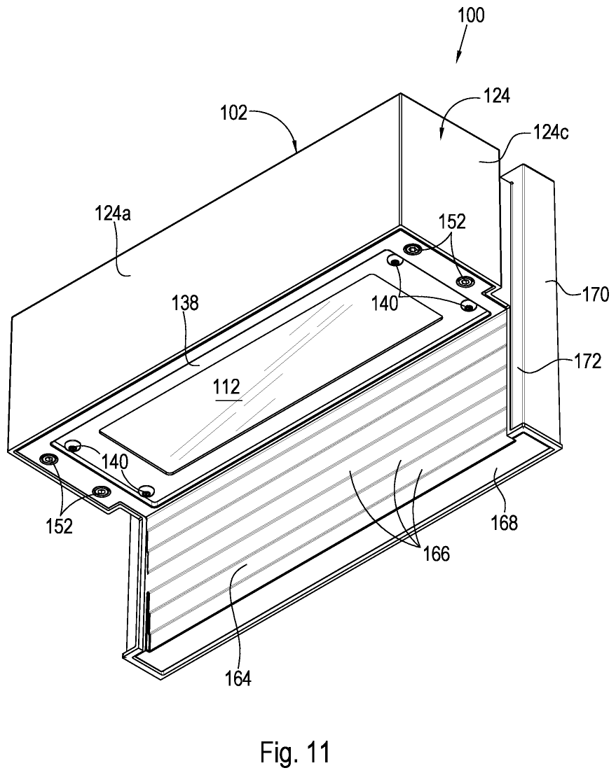

Turning now to FIGS. 5 to 11, a second embodiment of the invention is shown. In this version, a luminaire housing 100 comprises a base component 102 defining a first cavity 104, the first cavity 104 corresponding to a control gear housing for accommodating luminaire control gear 105.

The luminaire housing 100 further comprises a lighting sub-assembly 106 securable to the base component 102 so as to cover and enclose the first cavity 104. The lighting sub-assembly 106 comprises an intermediate plate, also called intermediate support 108 carrying lighting elements 110, a cover 112 comprising a planar glass plate, and a first seal arrangement 114 between the cover 112 and the intermediate support 108 so as to define the sealed lighting sub-assembly 106.

The luminaire housing 100 further comprises a second seal arrangement 116 between the lighting sub-assembly 106 and the base component 102.

As with the first version shown in FIGS. 1 to 4, the base component 102 includes at least one mounting formation 118, here a plurality of holes in a base wall 120, see further, outside the first cavity 104 and the lighting sub-assembly 106. This enables the luminaire housing 100 to be fitted to a supporting structure, such as a wall, so as to prevent the ingress of moisture and other contaminants into the first cavity 104 and the lighting sub-assembly 106, as described above with reference to the first version.

In this version, the base component 102 comprises a base wall 120, a first, inner peripheral wall 122 that defines the first cavity 104, and a second, outer peripheral wall 124 that surrounds the first, inner peripheral wall 122. In the illustrated embodiment, the base wall 120 is intended to be fitted to a wall by bolts extending through apertures 118 in the base wall 120, and a portion of the base wall 120 forms a portion 124d of the outer peripheral wall 124 which surrounds the inner peripheral wall 122. In other words, the base component 102 comprises a base wall 120 and a body 121 fitted to the base wall, wherein the body 121 comprises the inner peripheral wall 122, the front and side portions 124 a, 124b, 124c of the outer peripheral wall 124, and a top wall 125. The base wall 120 defines an aperture 126 to ultimately enable the electrical wiring of the luminaire control gear 105 and related components in the first cavity 104. To that end the inner peripheral wall 122 may be provided with a connection interface 127. Preferably the connection interface 127 is provided in a tight manner in the inner peripheral wall 122.

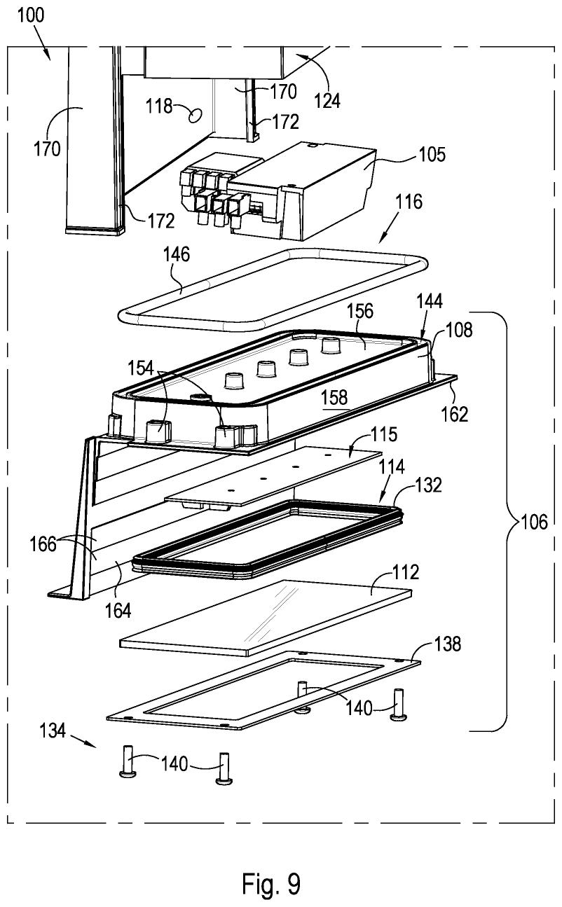

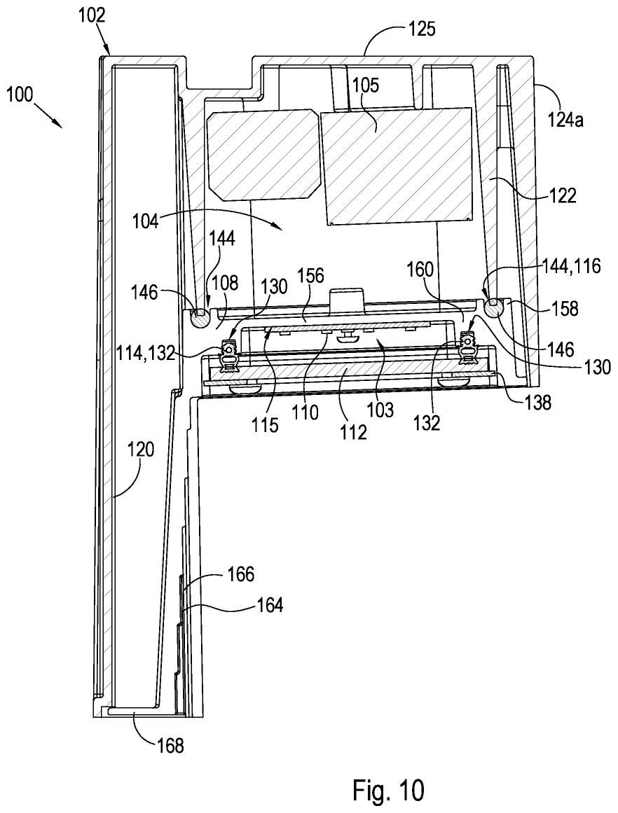

In an embodiment, the intermediate support 108 comprises a plate portion 156 for accommodating a PCB 115 with the lighting elements 110. The plate portion 156 has at an upper side a peripheral portion 158 configured for cooperating with the second seal arrangement 116, see FIG. 9, and at a lower side a peripheral portion 160 configured for cooperating with the first seal arrangement 114, see FIG. 10. In this version, the intermediate support 108 further comprises a downwardly extending plate 164 that extends downwardly away from the plate portion 156 and an extending support plate 168 that can abut against a lower end of the base wall 120. Conveniently, the base wall is provided with side holding plates 170 with inwardly turned lips 172 to cooperate with edges of the downwardly extending plate 164. More generally, the intermediated support 108 may be formed such that it forms a housing part delimiting a rear internal space before the base wall 120, and behind the first cavity 104 and the downwardly extending plate 164.

Thus, in this version, the first, inner peripheral wall 122 and the second, outer peripheral wall 124 extend substantially parallel to the base wall 120, with the plate portion 156 of the intermediate support 108 of the lighting sub-assembly 106 accordingly being substantially transverse (i.e. at right angles) to the base wall 120. The base wall 120 has a mounting wall plate portion 128 that extends away from the lighting sub-assembly 106, with the mounting wall plate portion 128 defining the mounting formations 118 to enable the base component 102 to be mounted to the supporting structure.

In the illustrated embodiment, the base wall 120 has a mounting wall plate portion 128 extending downwardly of the lighting sub-assembly 106. However, alternatively or in addition, the base wall may comprise a mounting wall plate portion extending upwardly of the lighting sub-assembly and upwardly of the first cavity. Also, the base wall could extend only behind the first cavity and the lighting sub-assembly. Also, the illustrated embodiment could be used upside down, i.e. as an uplighter. Further, the base component could be provided with multiple first cavities as defined above and multiple lighting sub-assemblies 106 associated therewith.

As best shown in FIGS. 5 and 10, an outer, lower side of the intermediate support 108 defines a first peripheral sealing channel 130 to accommodate a first sealing body 132 (such as a silicone gasket) therein, the first sealing body 132 corresponding to the first seal arrangement 114. A first securing arrangement 134 (e.g. a frame 138 with bolts 140) is arranged to releasably and sealingly secure the cover 112 against the first sealing body 132 so as to define the sealed lighting sub-assembly 106. In that manner, the cover 112 and the intermediate support 108 define a second cavity 103 in which the lighting elements 110 are arranged.

The lighting sub-assembly 106 is securable to the base component 102 via a second securing arrangement 136 (e.g. comprising bolts 152 extending through the intermediate support 108 into locking formations such as bores 148 provided in the base component 102 outside of the first cavity 104), so as to sealingly engage the second seal arrangement 116.

In an embodiment, the lighting sub-assembly 106 comprises a securing frame 138 that can be releasably secured with the first securing arrangement 134 (typically with bolts 140) to first locking formations 142, which define corresponding apertures, disposed around the inside of the plate portion 156 of the intermediate support 108, as best shown in FIG. 5. The securing frame 138 is thus arranged to sealingly sandwich the cover 112 against the first sealing body 132 arranged within the first peripheral sealing channel 130.

In an embodiment, an inner, upper side of the intermediate support 108 defines a second peripheral sealing channel 144 to accommodate a second sealing body 146 (such as a silicone gasket) therein. The second sealing body 146 corresponds to the second seal arrangement 116 and is arranged to be sealingly fitted against the outer edge of the first, inner peripheral wall 122 of the base component 102, as shown in FIG. 10, with the second securing arrangement 136.

The second securing arrangement 136 comprises a plurality of second locking formations 148 disposed around the inside of the second peripheral wall 124, the second locking formations 148 defining apertures 150 for receiving locking members (such as bolts 152) that extend through corresponding apertures defined in corresponding third locking formations 154 on the intermediate support 108.

In an embodiment, the intermediate support 108 comprises the plate portion 156 for accommodating the lighting elements 110, the peripheral portion 158 which defines the second peripheral sealing channel 144. The intermediate support 108 comprises the peripheral portion 160 formed as a plate wall that extends outwardly from the plate portion 156, the peripheral plate wall 160 defining the first peripheral sealing channel 130. The intermediate support 108 further comprises a peripheral flange 162 that includes the third locking formations 154 on an inner, upper side of the peripheral flange 162.

In this version, the downwardly extending plate 164 of the intermediate support 108 may be provided as a reflective portion configured for reflecting light emitted by the lighting elements 110 through the cover 112. To that end, the plate 164 may comprise a plurality of angled reflector strips 166.

Embodiments of the present invention thus provide a simple arrangement to prevent the ingress of moisture and other contaminants into the first cavities 14, 104 and the lighting sub-assemblies 30, 106, thus maintaining/ensuring the IP ratings of both.

1. A luminaire housing comprising:
a base component defining a first cavity, the first cavity corresponding to a control gear housing for accommodating luminaire control gear;
a lighting sub-assembly securable to the base component so as to cover and enclose the first cavity, the lighting sub-assembly comprising an intermediate plate carrying lighting elements, a cover, and a first seal arrangement between the cover and the intermediate plate so as to define a sealed lighting sub-assembly; and
a second seal arrangement between the lighting sub-assembly and the base component,
wherein the base component includes at least one mounting formation outside the first cavity and the lighting sub-assembly, to enable the luminaire housing to be fitted to a supporting structure, so as to prevent the ingress of moisture and other contaminants into the first cavity and the lighting sub-assembly.

2. The luminaire housing of claim 1, wherein the base component comprises:
a base wall;
a first, inner peripheral wall that defines the first cavity; and
a second, outer peripheral wall that surrounds the first, inner peripheral wall.

3. The luminaire housing of claim 2, wherein an outer side of the intermediate plate defines a first peripheral sealing channel to accommodate a first sealing body therein, the first sealing body corresponding to the first seal arrangement, with a first securing arrangement being provided to releasably and sealingly secure the cover against the first sealing body so as to define the sealed lighting sub-assembly, with the lighting sub-assembly being securable to the base component via a second securing arrangement, so as to sealingly engage the second seal arrangement.

4. The luminaire housing of claim 3, wherein an inner side of the cover includes a transversely extending sealing rim arranged to abut against the first sealing body within the first peripheral sealing channel of the intermediate plate.

5. The luminaire housing of either claim 3 or claim 4, wherein the first securing arrangement comprises a plurality of clipping arrangements comprising a plurality of downwardly extending flanges extending from the cover and a corresponding plurality of securing tabs on the intermediate plate to engage the downwardly extending flanges.

6. The luminaire housing of any one of claims 2 to 5, wherein the second, outer peripheral wall defines a peripheral skirt that surrounds the base wall, with the first, inner peripheral wall and the second, outer peripheral wall accordingly extending away from, so as to be transverse to, the base wall, with the intermediate plate of the lighting sub-assembly accordingly being substantially parallel to the base wall.

7. The luminaire housing of claim 6, wherein the second securing arrangement comprises a plurality of locking formations disposed around the periphery of the intermediate plate, the locking formations defining apertures for receiving locking members that extend through corresponding apertures defined in the peripheral skirt of the outer peripheral wall.

8. The luminaire housing of any one of claims 2 to 7, wherein a flange extends between the first and second peripheral walls, the flange defining the at least one mounting formation, to enable the base component to be mounted to the supporting structure, each mounting formation comprising a mounting body defining an elongate slot to accommodate a securing member.

9. The luminaire housing of any one of claims 2 to 8, wherein a flange extends between the first and second peripheral walls, the flange defining a second peripheral sealing channel, around the first cavity, to accommodate a second sealing body therein, the second sealing body corresponding to the second seal arrangement.

10. The luminaire housing of claim 9, wherein the intermediate plate comprises:
a plate portion for accommodating the lighting elements;
an inwardly extending peripheral ring to abut against the second sealing body provided in the second sealing channel of the flange; and
a peripheral plate wall extending outwardly from the plate portion, with the first peripheral sealing channel being defined around the peripheral plate wall.

11. The luminaire housing of claim 2 or 3, wherein the first, inner peripheral wall and the second, outer peripheral wall are adjacent the base wall, with a plate portion (156) of the intermediate plate of the lighting sub-assembly accordingly being at an angle to the base wall, said angle being in a range of 90°+/−30°, with the base wall having a mounting wall plate portion that extends away from the lighting sub-assembly, with the mounting wall plate portion defining the at least one mounting formation to enable the base component to be mounted to the supporting structure.

12. The luminaire housing of claims 3 and 11, wherein the lighting sub-assembly comprises a securing frame that can be releasably secured with the first securing arrangement to the intermediate plate, with the cover comprising a planar cover plate, with the securing frame being arranged to sealingly sandwich the planar cover plate against the first sealing body arranged within the first peripheral sealing channel, with the inner side of the intermediate plate defining a second peripheral sealing channel to accommodate a second sealing body therein, the second sealing body corresponding to the second seal arrangement and being arranged to be sealingly fitted against the first, inner peripheral wall of the base component with the second securing arrangement.

13. The luminaire housing of claim 12, wherein the second securing arrangement (136) comprises a plurality of second locking formations (148) disposed around the inside of the second peripheral wall, the second locking formations defining apertures for receiving locking members (152) that extend through corresponding apertures defined in corresponding third locking formations (154) on the intermediate plate.

14. The luminaire housing of claim 3 or 12 or 13, wherein the intermediate plate (108) comprises:
a plate portion (156) for accommodating the lighting elements, a peripheral portion (158) of which defines the second peripheral sealing channel;
a peripheral plate wall (160) extending outwardly from the plate portion, the peripheral plate wall defining the first peripheral sealing channel.

15. The luminaire housing of claims 13 and 14, wherein the intermediate plate further comprises:
a peripheral flange (162) that includes the third locking formations on an inner side of the peripheral flange.

16. The luminaire housing of claim 11 and 14 or 15, wherein the intermediate plate further comprises a reflector plate that extends away from the plate portion, the reflector plate being arranged to cover at least partially the mounting wall plate portion of the base wall.

17. The luminaire housing of claim 16, wherein the reflector plate comprises a plurality of angled reflector strips and terminates in a rearwardly extending support plate that can abut against a lower end of the mounting wall plate portion of the base wall, with the mounting wall plate portion including side holding plates with inwardly turned lips to snugly accommodate the reflector plate.

18. A luminaire comprising:
a base component (102) comprising a base wall (120) and a body (121) fitted to the base wall, the body comprising:
a first, inner peripheral wall (122) that defines a first cavity (104) at a distance of the base wall, the first cavity corresponding to a control gear housing for accommodating luminaire control gear; and
a second outer wall (124a, 124b, 124c) arranged such that the second outer wall (124a, 124b, 124c) and the base wall (120) surround the first, inner peripheral wall (122);
a lighting sub-assembly (106) secured to the body (121) at a location outside of the first cavity and so as to cover and enclose the first cavity (104), the lighting sub-assembly comprising an intermediate support (108) carrying lighting elements (110) and a cover (112),
wherein the base wall includes at least one mounting formation outside the first cavity and the lighting sub-assembly, to enable the luminaire housing to be fitted to a supporting structure.

19. The luminaire of claim 18, wherein the base wall includes a mounting wall plate portion that extends away from the lighting sub-assembly, with the mounting wall plate portion defining the at least one mounting formation to enable the base component to be mounted to the supporting structure.

20. The luminaire housing of claim 18 or 19, wherein the intermediate support comprises a plate portion (156) extending at an angle of 90°+/−30° with respect to the base wall (120), said plate portion carrying the lighting elements.

21. The luminaire housing of the previous claim, wherein the intermediate support (108) comprises a housing wall portion (164) extending at an angle with respect to the plate portion (156), said housing wall portion being configured to form, together with the base component (102) a rear housing with an internal space between the base wall (120) and the housing wall portion (164) of the intermediate support (108).

22. The luminaire housing of the previous claim, wherein the housing wall portion of the intermediate support of the lighting sub-assembly is configured to be reflective.

23. The luminaire housing of claim 21 or 22, wherein the rear housing formed by the base component (102) and the housing wall portion (164) defines an internal space extending behind the first cavity (104) and below and/or above the first cavity (104).

24. The luminaire housing of any one of the claims 18-23, wherein the intermediate support (108) is secured to one or more locking formations (148) located in between the first inner wall (122) and the second outer wall (124).

25. The luminaire housing of any one of the claims 18-24, wherein the base wall (120) extends substantially parallel to the second outer wall (124a, 124b, 124c).

26. The luminaire housing of any one of the claims 18-25, wherein the lighting sub-assembly comprises a first seal arrangement (114) between the cover (112) and the intermediate support (108) so as to define a sealed lighting sub-assembly.

27. The luminaire housing of any one of the claims 18-26, wherein a second seal arrangement (116) is provided between the lighting sub-assembly (106) and the base component (102).

28. The luminaire housing of claims 26 and 27, wherein an outer side of the intermediate support (108) defines a first peripheral sealing channel to accommodate a first sealing body (114, 132) therein, the first sealing body corresponding to the first seal arrangement, with a first securing arrangement (134) being provided to releasably and sealingly secure the cover (112) against the first sealing body so as to define the sealed lighting sub-assembly, with the lighting sub-assembly (106) being securable to the base component via a second securing arrangement (136), so as to sealingly engage the second seal arrangement (116).
